(19) United States
(12) Patent Application Publication
(10) Pub. No.: US 2008/0141046 A1
(43) Pub. Date: Jun. 12, 2008

(54) PARTIAL DATA FLOW FUNCTIONAL GATING USING STRUCTURAL OR PARTIAL OPERAND VALUE INFORMATION

(75) Inventors: Lei Chen, Austin, TX (US); Jente B. Kuang, Austin, TX (US); Brian R. Mestan, Austin, TX (US); Hung C. Ngo, Austin, TX (US); Kevin J. Nowka, Georgetown, TX (US)

Correspondence Address: CANTOR COLBURN LLP - IBM AUSTIN, 20 Church Street, 22nd Floor, Hartford, CT, 06103, US

(73) Assignee: International Business Machines Corporation, Armonk, NY (US)

(21) Appl. No.: 11/567,395

(22) Filed: Dec. 6, 2006

(51) Int. Cl. G06F 1/32

(52) U.S. Cl. 713/300

(57) ABSTRACT

The present invention relates to a methodology for controlling the power consumption in a computing device based upon extended register file extension values, the method further comprising the steps of identifying an upper bit data register value and a lower bit data register value for a data register value, and inputting the upper bit data register value to a detect logic component, wherein the upper bit data register value is used to generate a data register extension value. The method further comprises the steps of utilizing the data register extension value as a power control signal serving to activate or deactivate a power supply signal to a segment of a data path, and updating the data register extension value in a subsequent data register write computational function.

### FIELD OF THE INVENTION

This invention relates to functional gating of execution units and data paths, and more particularly to the reduction of power within central processing units.

### DESCRIPTION OF BACKGROUND

Before our invention conventional computer architectural definitions specifying full-sized data registers and data paths that are configured to accommodate such full-sized registers influenced the micro-architecture design of computing systems. However, as can best be determined, the individual large size registers that are implemented within many computing systems are not fully utilized. As a power saving functional feature, clock gating has conventionally be used as an operation-based procedure, i.e., within a processing system an execution unit is switched off if there is not resource request that is associated the execution unit during a particular cycle. Thus, current central processing unit design is based on specific system requirements (e.g., for 64-bit mode executions, 64-bit data path exists to accommodate 64-bit data and computation operation).

However, it is rare that during program execution full-size data paths are fully needed. That is, typically a partial data path is sufficiently large enough to carry out any data and occupational needs. Therefore, there exist a need to assist in the implementation of partial data flow functional gating of data paths as an active on-demand feature of a central processing unit's functional power saving operations.

### SUMMARY OF THE INVENTION

The shortcomings of the prior art are overcome and additional advantages are provided through the provision of a method for controlling the power consumption in a computing device based upon extended register file extension values, the method further comprising the steps of acquiring a data register value during a data register write computational function, identifying an upper bit data register value and a lower bit data register value for the data register value, and inputting the upper bit data register value to a detect logic component, wherein the upper bit data register value is used to generate a data register extension value.

The method further comprises the steps of outputting the data register extension value from the detect logic component, writing the lower bit data register value, the upper bit data register value to a register file, and writing the generated data register extension value to an extended register file. Additionally, the method comprise the steps of utilizing the data register extension value as a power control signal serving to activate or deactivate a power supply signal to a segment of a data path, and updating the data register extension value in a subsequent data register write computational function.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which results in substantial power savings in the power consumption that is necessitated within conventional processor operational functions.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram detailing functional aspects of the present invention

FIG. 2 illustrates one example of a flow diagram detailing partial data flow functional gating.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the present invention relate to differing mechanisms that are used to support the functional gating of execution units and data paths that are situated within central processing units using techniques that specifically correlate to the width of operation data. Depending on the specific processor design, the functional gating as implemented within aspects of the present invention can include clock gating, power gating, or both. A central objective of the present invention is to capture and utilize operand information from different processor sources, such operand information being obtained from, but not limited to, instruction operation code, pre-decoded bits, machine state registers, and partial value information. The acquired operand information is subsequently utilized assist in power-saving operations pertaining to gating off of unneeded parts of the execution unit and data path.

The information that is necessary for performing the functional aspects of the present invention (i.e., the instruction operating code, pre-decode bits, machine state registers, etc . . . ) already exist by design in current computing processing system. Within aspects of the present invention, the application of the operand information is extended to functional gating operations so that finer-grain clock and power gating operations can be utilized to reduce the power consumption within a processing system. Specifically, within aspects of the present invention, for partial register value information the integer register file is appended with non-performance critical extra register bits; the bits being used to represent indications of specific register value information.

Within aspects of embodiments of the present invention the extension bits are updated during register write operations. Therefore, as a result of this particular configuration, the extension bit updating function does not impact the system critical path. Conventionally, previous approaches have required that extra logic be added to the critical path, the logic thereafter being accessed every time the critical path is exercised. This arrangement results in slower processing timing, in addition to the high power consumption. In contrast, the present approach only exercises an update logic operation when the register value is updated. Thus, no indirect timing impact is introduced, and the modifications to the micro-architecture of a computing system are required to accommodate the present approach.

As mentioned above, current central processing unit design is based on specific system requirements (e.g., for 64-bit mode executions, 64-bit data path exist to accommodate 64-bit data and computation operations). However, during program execution, full-size data paths are rarely needed. That is, typically a partial data path is large enough to carry out any systematic data and computational needs. Thus, higher order data paths within a processing system can be turned of for partial width operations (e.g., byte, half word, or word operations) in order to assist in the conservation of power.

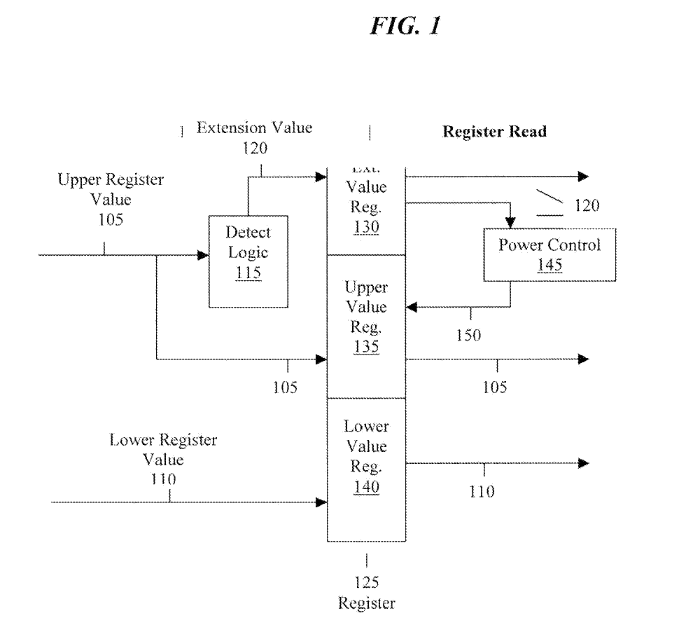

Turning now to the drawings in greater detail, it will be sen that in FIG. 1 there is a high level diagram detailing the generation of resister extension bit values. Within aspects of the preset invention the register extension bit values are generated, and subsequently updated, within register writing operations. As show in FIG. 1, during a register write operation, the lower register value 110, and upper register value 105 are input to the register 125, concurrently, the upper register value is input to detect logic component 115. The detect logic component 115 functions to read the upper register input value 105, and thereafter generate or update an extension register value 120. In its simplest embodiment, the extension register value 120 can be comprised with a single bit, the bit being used to indicate the value state of the upper register value 105 (e.g., whether or not the upper register value contains all 0s, and therefore no significant data). The register values 105 and 110 are written to the register 125, wherein the values are respectfully stored at the register file locations 135, 140, and the extension register value 120 is written to an extended register file location 130.

The extension register value 120 is input to a power control component 145, wherein the extension register value 120 is used as a power control signal 150. As a power control signal 150, the extension register value 120 serves as either a power gate for the subsequent upper register value 105 data path, or as a control signal to influence a clock gating signal that will disable the data path of the upper register value 105. Within further aspects of the present invention, for combined clock/power gating control, the register extension bit values from different operands are combined to generate a final control signal, and thereafter used to gate a power rail for a specific data path potion.

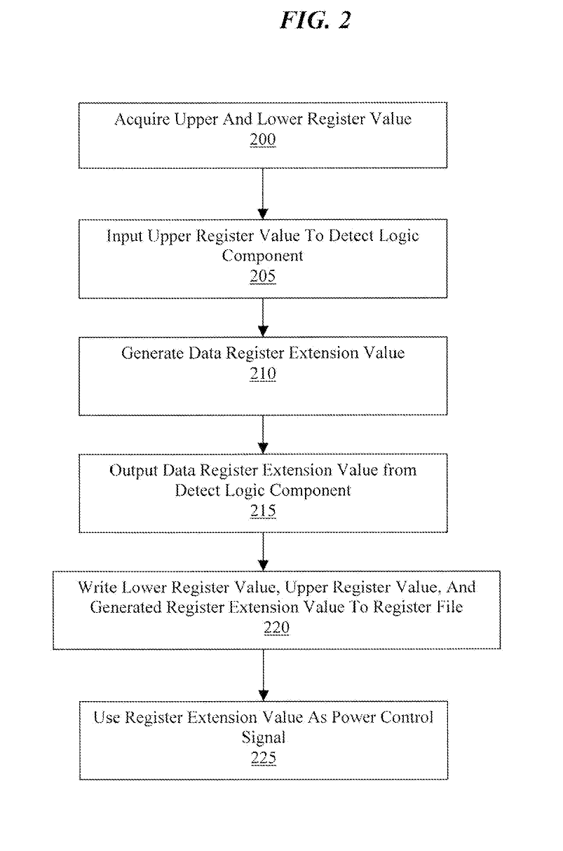

FIG. 2 shows a flow diagram of an aspect for the partial data functional gating operation of the present invention. At step 200 a register value is acquired during a data register write computational function, wherein after, an upper bit data register value 105 and a lower bit data register value 110 are identified for the data register value. At step 205, the upper bit data register value 105 is input to a detect logic component 115, wherein the upper bit data register value 105 is used to generate a data register extension value 120. After the generation of the data register extension value 120, at step 215, the data register extension value 120 is output from the detect logic component 115. Thereafter, the register write operation is completed by the lower bit data register value 110 and the upper bit data register value 105 being written to the register file 125, and the generated data register extension value 120 being written to an extended register file location 130 (step 220). Lastly, at step 225, the register extension value 120 is used as a power control signal 150 in order to affect either clock gating or power gating operations within a processing system.

Register value based functional gating is a straightforward approach for certain computational operations in which a register value computation width of an operand can easily be determined using simple register extension bits. However, for some logical operations (e.g., shift and rotate operations), the computational width of the register value may not be straightforward. Nonetheless, within aspects of the present invention there are several approaches to mitigate this problem. Within additional aspects of embodiments of the present invention the greater extension value is used in conjunction with control logic to make determinations in regard to clock/power gating operational modes within a processing system.

For example, in exemplary embodiments, a data path segment is turned off, or deactivated, only in the event that implemented control logic can properly determine the part of the data path segment that will not be used, otherwise, the data path is left on. Thus, potential power savings will be lower, in addition to the benefit of having incurred minimal complexity in regard to the processing design. A yet further aspect of the present invention comprises that the data path segment being turned off, or deactivated in the event that the control logic predicts only the part of the data path that is currently needed. In this case, pre-existing recovery logic is implemented, and subsequently activated to handle any determination errors, for example, in the event that the functional gating control logic has not properly predicted the data path segment usage and turned off a needed portion of the data path.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for controlling the power consumption in a computing device based upon exyrnded register file extension values, the method further comprising the steps of:
acquiring a data register value during a data register write computational function; identifying an upper bit data register value and a lower bit data register value for the data register value;
inputting the upper bit data register value to a detect logic component, wherein the upper bit data register value is used to generate a data register extension value;
outputting the data register extension value from the detect logic component;
writing the lower bit data register value and the upper bit data register value to a register file;
writing the generated data register extension value to an extended register file; and
utilizing the data register extension value as a power control signal serving to activate or deactivate a power supply signal to a segment of a data path.

2. The method of claim 1, wherein the data path for the upper bit data register value is deactivated in response to a partial-width register value operation.

3. The method of claim 1, further comprising the step of updating the data register extension value in a subsequent data register write computational function.

4. The method of claim 3, wherein the step of utilizing the data register extension value as a power control signal further comprises utilizing the power control signal to initiate the performance of a clock gating function upon the data path.

5. The method of claim 3, wherein the step of utilizing the data register extension value as a power control signal further comprises utilizing the power control signal to initiate the performance of a power gating function upon the data path.

6. A computer program product that includes a computer readable medium useable by a processor, the medium having stored thereon a sequence of instructions which, when executed by the processor, causes the processor to control the power consumption in a computing device based upon extended register file extension values, wherein the computer program product executes the steps of
acquiring a data register value during a data register write computational function;
identifying an upper bit data register value and a lower bit data register value for the data register value;
inputting the upper bit data register value to a detect logic component, wherein the upper bit data register value is used to generate a data register extension value;
outputting the data register extension value from the detect logic component;
writing the lower bit data register value and the upper bit data register value to a register file;
writing the generated data register extension value to an extended register file; and
utilizing the data register extension value as a power control signal serving to activate or deactivate a power supply signal to a segment of a data path;

7. The computer program product of claim 6, further comprising the step of updating the data register extension value in a subsequent data register write computational function.

8. The computer program product of claim 7, wherein the step of utilizing the data register extension value as a power control signal further comprises utilizing the power control signal to initiate the performance of a clock gating function upon the data path.

9. The computer program product of claim 7, wherein the step of utilizing the data register extension value as a power control signal further comprises utilizing the power control signal to initiate the performance of a power gating function upon the data path.

10. An article of manufacture for control the power consumption in a computing device based upon extended register file extension values, the article of manufacture storing machine readable instructions, which when executed cause the machine to perform the steps of:
identifying an upper bit data register value and a lower bit data register value for a data register value;
inputting the upper bit data register value to a detect logic component. wherein the upper bit data register value is used to generate a data register extension value;
outputting the data register extension value from the detect logic component;
writing the lower bit data register value and the upper bit data register value to a register file;
writing the generated data register extension value to an extended register file;
utilizing the data register extension value as a power control signal serving to activate or deactivate a power supply signal to a segment of a data path; and
updating the data register extension value in a subsequent data register write computational function.

11. The article of manufacture of claim 10, wherein the step of utilizing the data register extension value as a power control signal further comprises utilizing the power control signal to initiate the performance of a clock gating function upon the data path.

12. The article of manufacture of claim 10, wherein the step of utilizing the data register extension value as a power control signal further comprises utilizing the power control signal to initiate the performance of a power gating function upon the data path.
